(19) United States
(12) Patent Application Publication
(10) Pub. No.: US 2024/0162764 A1
(43) Pub. Date: May 16, 2024

(54) ROTARY ELECTRIC MACHINE

(71) Applicant: NIDEC CORPORATION, Kyoto (JP)

(72) Inventor: Tomoya UEDA, Kyoto (JP)

(21) Appl. No.: 18/548,220

(22) PCT Filed: Jun. 13, 2022
(86) PCT No.: PCT/JP2022/023594

§ 371 Date: Aug. 29, 2023

(30) Foreign Application Priority Data
Aug. 25, 2021 (JP) 2021-137553

(51) Int. Cl. H02K 1/18; H02K 1/276; H02K 21/14; H02K 29/03

(52) U.S. Cl. CPC H02K 1/185; H02K 1/276; H02K 21/14; H02K 29/03

(57) ABSTRACT

A rotary electric machine includes: a rotor in which a plurality of permanent magnets are embedded in an outer peripheral portion, the rotor being rotatable; a stator fixed around the rotor and provided with a plurality of coils in a stator core; and a motor housing that accommodates the rotor and the stator therein. The stator is fixed to the motor housing by a bolt (fastener) inserted into a plurality of fixing portions protruding radially outward from an outer periphery of the stator core, and a flux barrier penetrating in an axial direction is formed near the fixing portion of the stator core and at a position not overlapping the fixing portion in a radial direction. Here, the fixing portions are disposed at equiangular pitches in the circumferential direction of the stator core, and the flux barriers are formed on both sides of the fixing portion in a circumferential direction.

### CROSS-REFERENCE TO RELATED APPLICATIONS

This is the U.S. national stage of application No. PCT/JP2022/023594, filed on Jun. 13, 2022, and priority under 35 U.S.C. § 119(a) and 35 U.S.C. § 365(b) is claimed from Japanese Patent Application No. 2021-137553, filed on Aug. 25, 2021.

### FIELD OF THE INVENTION

The present invention relates to a rotary electric machine adopting a structure in which a stator accommodated in a motor housing is fixed to the motor housing by a fastener such as a bolt.

The present application claims priority based on Japanese Patent Application No. 2021-137553 filed in Japan on Aug. 25, 2021, the contents of which are incorporated herein by reference.

### BACKGROUND

In a rotary electric machine configured by accommodating a rotor that is rotatable and a stator disposed on an outer periphery of the rotor in a motor housing, the stator is fixed to the motor housing. As a method of fixing the stator to the motor housing, there is a method using a shrink fitting method, a bolt fastening method, or both methods. In addition, depending on the motor, a press-fitting method or an adhesion method may be adopted as a method of fixing the stator to the motor housing.

When a bolt fastening method is adopted as a method of fixing the stator to the motor housing, a plurality of fixing portions protruding radially outward are formed on the outer periphery of the stator, and the stator is fixed to the motor housing by fastening a fastener such as a bolt inserted into each fixing portion.

Meanwhile, a stator core constituting a stator is formed in a cylindrical shape by laminating a plurality of ring-shaped electromagnetic steel plates in an axial direction and connecting the plurality of electromagnetic steel plates to each other by caulking or the like. However, in order to suppress an eddy current loss generated in the stator core to a low level, conventionally, a circumferential pitch between a connecting portion and a fixing portion by caulking or the like of the electromagnetic steel plates constituting the stator core is defined. Specifically, when the number of fastening portions is an odd number, the fixing portions are formed at a circumferential pitch that is the same as or a divisor of the circumferential pitch of the fastening portions with respect to the rotor rotation center, and when the number of fastening portions is an even number, the fixing portions are formed at a circumferential pitch that is a divisor of the circumferential pitch of the fastening portions with respect to the rotor rotation center or a divisor of 180°.

In addition, there is known a configuration in which, in a rotary electric machine adopting a shrink fitting method and a bolt fastening method as a method of fixing a stator, a recess is formed in a root of a fixing portion (protruding portion) of the stator in order to increase a fastening force of the stator to a motor housing and suppress deformation of the stator due to the fastening.

When the bolt fastening method is adopted as a method of fixing the stator to the motor housing, a plurality of fixing portions in which insertion holes for inserting bolts are formed are integrally projected radially outward from the outer peripheral edge of the stator core. However, in the stator core provided with these fixing portions, the distribution of the magnetic flux density in the vicinity of the fixing portions becomes non-uniform in the circumferential direction with respect to the stator core provided with no fixing portion. Alternatively, in a three-phase AC motor, there is a possibility that magnetic imbalance due to imbalance of the magnetomotive force of the three phases (U, V, W phases) or imbalance of the three-phase current occurs. For this reason, in a rotary electric machine adopting a bolt fastening method as a method of fixing a three-phase AC motor or a stator, a torque ripple (fluctuation range of output torque) becomes large, and a problem that vibration and noise become large occurs.

### SUMMARY

One aspect of an exemplary rotary electric machine of the present invention includes: a rotor in which a plurality of permanent magnets are embedded in an outer peripheral portion, the rotor being rotatable; a stator fixed around the rotor and provided with a plurality of coils in a stator core; and a motor housing that accommodates the rotor and the stator therein. The stator is fixed to the motor housing by a fastener inserted into a plurality of fixing portions protruding radially outward from an outer peripheral edge of the stator core. A flux barrier penetrating in an axial direction is formed near the fixing portion of the stator core and at a position not overlapping the fixing portion in a radial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal sectional view of a rotary electric machine according to an embodiment of the present invention;

FIG. 2 is a sectional view taken along line A-A of FIG. 1;

FIG. 3 is an enlarged detailed view of a portion B in FIG. 2;

FIG. 4 is an enlarged detailed view of a portion C in FIG. 2; and

FIG. 5 is a bar graph illustrating a torque ripple in each electrical angle order of the rotary electric machine according to the embodiment of the present invention in comparison with a torque ripple of a conventional rotary electric machine including a stator without a fixing portion and a stator with a fixing portion.

### DETAILED DESCRIPTION

Hereinafter, an embodiment of the present invention will be described with reference to the drawings.

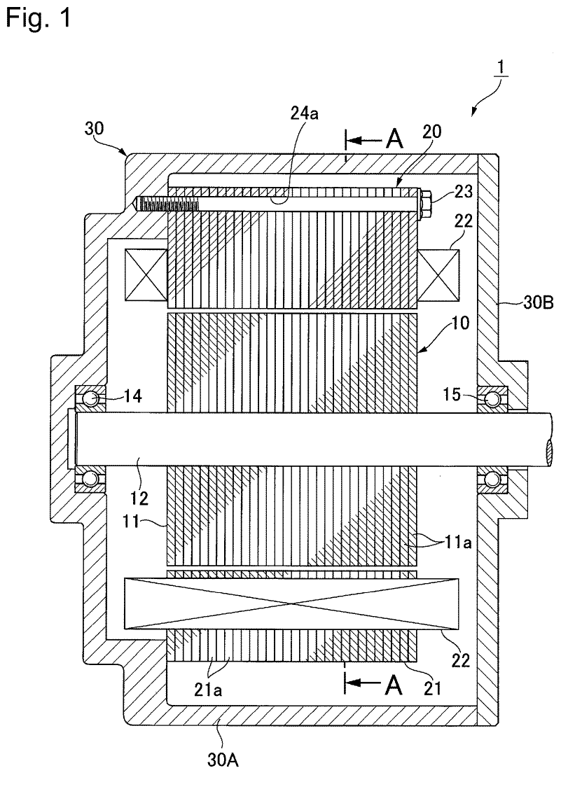

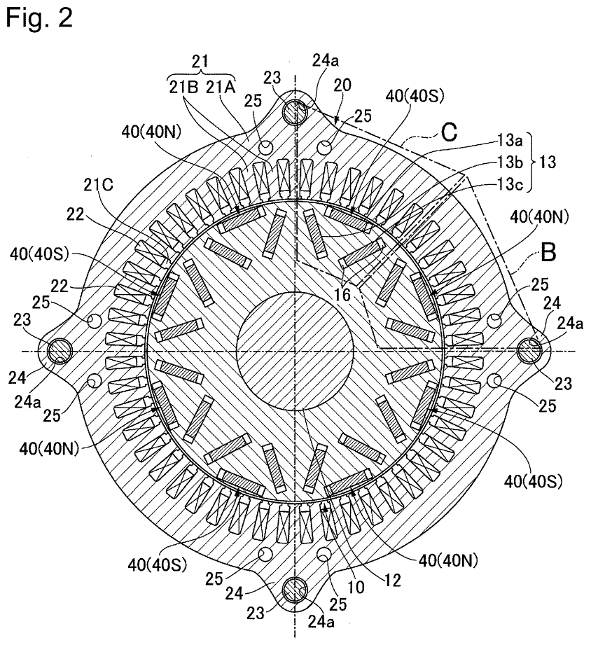

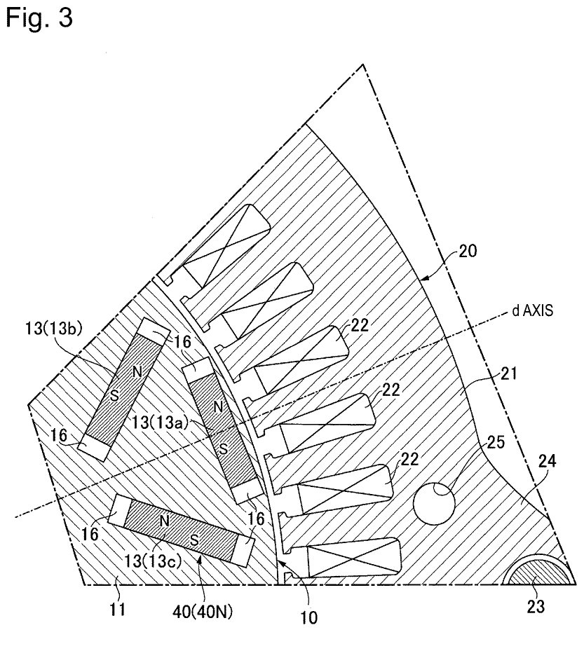

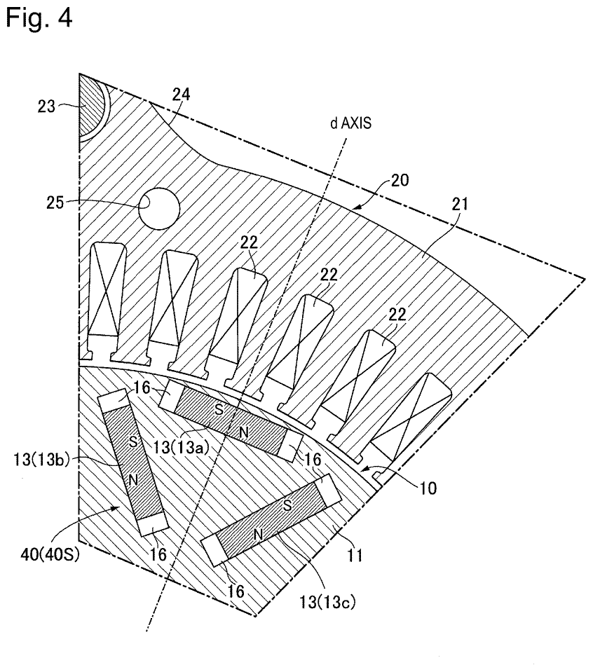

FIG. 1 is a longitudinal sectional view of a rotary electric machine according to an embodiment of the present invention, FIG. 2 is a sectional view taken along line A-A in FIG. 1, FIG. 3 is an enlarged detailed view of a portion B in FIG. 2, and FIG. 4 is an enlarged detailed view of a portion C in FIG. 2.

A rotary electric machine 1 according to the present embodiment is a three-phase synchronous motor generator, functions as an electric motor or a generator, and is used as a drive source of an electric vehicle (EV vehicle), a hybrid vehicle (HEV vehicle), or the like, for example. As illustrated in FIG. 1, the rotary electric machine 1 is configured such that a rotor 10 that is rotatable and a stator 20 fixed around the rotor 10 are accommodated in a motor housing 30. Hereinafter, the motor housing 30, the rotor 10, and the stator 20 constituting the rotary electric machine 1 will be described.

The motor housing 30 is configured such that an opening portion of a bottomed cylindrical main body 30A having one end surface opened is covered with a disk-shaped cover 30B, and is formed by die casting such as aluminum or an aluminum alloy, for example.

The rotor 10 includes a cylindrical rotor core 11, a round shaft-shaped shaft (motor shaft) 12 penetrating the center of the rotor core 11 in the axial direction (left-right direction in FIG. 1), and a plurality of permanent magnets 13 (see FIG. 2) embedded in the outer peripheral portion of the rotor core 11, and both axial end portions of the shaft 12 are rotatably supported by bearings (ball bearings) 14 and 15 respectively provided in the main body 30A and the cover 30B of the motor housing 30. Therefore, the rotor 10 is rotatable about the axial center (rotation center) of the shaft 12.

The rotor core 11 is formed in a columnar shape by laminating a plurality of thin electromagnetic steel plates 11a having a plate shape such as iron or an iron alloy, and each electromagnetic steel plate 11a is formed in a ring shape by punching by pressing, for example. Here, the plurality of electromagnetic steel plates 11a are integrated by being connected to each other by caulking, welding, or the like, and the rotor core 11 formed by stacking these electromagnetic steel plates 11a is fixed to the outer periphery of the shaft 12 by a method such as caulking, shrink fitting, or nut fastening. Therefore, the rotor core 11 is integrally rotatable together with the shaft 12.

In addition, as illustrated in FIG. 2, the plurality of permanent magnets 13 is configured as a rectangular plate elongated in the axial direction (the direction perpendicular to the paper surface of FIG. 2), and on the outer peripheral portion of the rotor core 11, a total of eight sets of magnetic pole portions 40 configured by disposing three permanent magnets 13 in a triangular shape are disposed at an equiangular pitch (45° pitch) in the circumferential direction. Hollow portions 16 each having a rectangular cross section are provided at both end portions in the longitudinal direction of each permanent magnet 13 of the rotor core 11 in a penetrating manner in the axial direction (a direction perpendicular to the paper surface of FIG. 2) (see FIGS. 3 and 4).

Here, the plurality of (eight sets of) magnetic pole portions 40 are constituted by an N magnetic pole portion 40N and an S magnetic pole portion 40S alternately disposed in the circumferential direction. In each of the N magnetic pole portions 40N, as illustrated in FIG. 3, one permanent magnet 13a disposed along the circumferential direction among the three permanent magnets 13 (13a, 13b, 13c) disposed in a triangular shape is disposed such that the N pole faces the outer peripheral side, and the two permanent magnets 13b and 13c disposed obliquely along the radial direction are disposed such that the N pole faces the opposing inner surface side. A d (direct) axis illustrated in FIG. 3 is a magnetic pole center line indicating a main magnetic flux direction of the N magnetic pole portion 40N.

On the other hand, in each S magnetic pole portion 40S, as illustrated in FIG. 4, among the three permanent magnets 13 (13a, 13b, 13c) disposed in a triangular shape, one permanent magnet 13a disposed along the circumferential direction is disposed so that the S pole faces the outer peripheral side, and the two permanent magnets 13b and 13c disposed obliquely along the radial direction are disposed so that the S pole faces the opposing inner surface side. A d (direct) axis illustrated in FIG. 4 indicates a main magnetic flux direction of the S magnetic pole portion 40S.

As illustrated in FIG. 2, the stator 20 includes a cylindrical stator core 21 and a plurality of (in the illustrated example, 48) coils 22. Here, the stator core 21 is formed in a columnar shape by laminating a plurality of thin electromagnetic steel plates 21a having a plate shape such as iron or an iron alloy, and each electromagnetic steel plate 21a is formed in a ring shape by punching by pressing, for example. Here, the plurality of electromagnetic steel plates 21a are integrated by being connected to each other by caulking, welding, or the like.

The stator core 21 includes a ring-shaped yoke 21A and a plurality of (in the illustrated example, 48) teeth 21B extending radially inside on the inner peripheral side of the yoke 21A. Here, the plurality of (48) teeth 21B are formed at equiangular pitches (7.5° pitches) in the circumferential direction, and slots 21C penetrating in the axial direction are respectively formed between the adjacent teeth 21B. Therefore, in the stator core 21, the same number (48) of slots 21C as the teeth 21B are formed at equiangular pitches (7.5° pitches) in the circumferential direction, and the rotary electric machine 1 according to the present embodiment adopts the form of 8 poles 48 slots.

In the stator core 21, a coil 22 configured by winding, for example, an insulation-coated conductive wire is provided around each of the plurality of teeth 21B disposed in the circumferential direction. Here, the plurality of coils 22 include a U-phase coil, a V-phase coil, and a W-phase coil. When an alternating current is applied to each coil 22 including the U-phase coil, the V-phase coil, and the W-phase coil, an AC magnetic field is generated in each coil 22 in a direction penetrating the U-phase coil, the V-phase coil, and the W-phase coil.

As illustrated in FIG. 1, the stator 20 configured as described above is fixed to the motor housing 30 by four bolts (only one bolt is illustrated in FIG. 1) 23 as fasteners. Specifically, as illustrated in FIG. 2, four fixing portions 24 forming a substantially triangular shape as viewed in the axial direction are integrally projected radially outward from the outer periphery of the stator core 21 (yoke 21A). That is, the four fixing portions 24 are integrally projected at an equiangular pitch (90° pitches) in the circumferential direction on the outer peripheral portion of the stator core 21, and bolt insertion holes 24a having a circular hole shape are respectively provided to penetrate the fixing portions 24 in the axial direction (the direction perpendicular to the paper surface of FIG. 2). In the shape formed by each fixing portion 24, that is, in a substantially triangular shape as viewed in the axial direction, the top of the triangle forms a convex arcuate surface, and the two oblique sides of the triangle form a concave arcuate surface smoothly connected to the outer periphery of the ring-shaped stator core 21 (yoke 21A). By setting the shape of each fixing portion 24 in this manner, stress concentration at both base end portions (connection portions with the yoke 21A) of the fixing portion 24 can be avoided, and occurrence of cracks and the like at both base end portions can be prevented.

As illustrated in FIG. 1, the stator 20 is fixed to the motor housing 30 by screwing a total of four bolts (FIG. 1 illustrates only one image) 23, which are respectively inserted into bolt insertion holes 24a penetrating the four fixing portions 24 (see FIG. 2), into the main body 30A of the motor housing 30.

Incidentally, in the rotary electric machine 1 according to the present embodiment, as illustrated in FIG. 2, a circular hole-shaped flux barrier 25 is provided penetrating in the axial direction (the direction perpendicular to the paper surface of FIG. 2) in the vicinity of each fixing portion 24 of the stator core 21 (yoke 21A) of the stator 20 and at a position not overlapping each fixing portion 24 in the radial direction and the circumferential direction, that is, at a position not entering the region of each fixing portion 24.

Here, in the present embodiment, as described above, the four fixing portions 24 are formed at equiangular pitches (90° pitches) in the circumferential direction on the outer periphery of the stator core 21, but the flux barriers 25 are formed on both sides of each fixing portion 24 in a circumferential direction. Therefore, in the present exemplary embodiment, a total of eight flux barriers 25 are formed in the yoke 21A of the stator core 21.

In the present exemplary embodiment, four fixing portions 24 are provided on the outer periphery of the stator core 21 in a protruding manner at equiangular pitches (90 degree pitches) in the circumferential direction, and the flux barriers 25 are formed on both sides of each fixing portion 24 in the circumferential direction. However, the number of fixing portions 24 and the number of flux barriers 25 are arbitrary. However, when the number of fixing portions 24 is 2 (the number of flux barriers 25 is 4), the mounting strength of the stator 20 to the motor housing 30 may be insufficient, and when the number of fixing portions 24 is 6 (the number of flux barriers 25 is 12), the mounting strength of the stator 20 to the motor housing 30 is increased, but there is a problem that the shape of the stator core 21 becomes complicated and the manufacturing cost increases. Therefore, in the present exemplary embodiment, the number of fixing portions 24 is set to 4, and the number of flux barriers 25 is set to 8.

Further, in the present embodiment, the shape of the flux barrier 25 is a circular hole shape, but is not limited thereto, and may be an elliptical hole shape, a polygonal hole shape, or the like, and the size of the flux barrier 25 can also be arbitrarily set within a range in which the object of the present invention is achieved.

Next, operations and effects of the rotary electric machine 1 according to the present embodiment will be described.

For example, in a case where the rotary electric machine 1 according to the present embodiment mounted on an electric vehicle (EV vehicle), a hybrid vehicle (HEV vehicle), or the like (hereinafter, simply referred to as a “vehicle”) acts as an electric motor that rotationally drives the wheels, a direct current output from a direct current power supply such as a battery (not illustrated) is converted into an alternating current by an inverter (not illustrated). When the alternating current is supplied to each of a plurality of (48) coils (U-phase, V-phase and W-phase coils) 22 provided in the stator 20 of the rotary electric machine 1, a rotating magnetic field is generated by these coils 22. Specifically, the magnetic flux of each coil (U-phase, V-phase and W-phase coils) 22 becomes a combined rotating magnetic flux, and the rotor 10 in which the plurality of permanent magnets 13 disposed in the region where the rotating magnetic flux is generated is embedded rotates in synchronization with the rotating magnetic flux.

That is, electric energy supplied from the battery is converted into rotational energy (mechanical energy) of the rotor 10 by the rotary electric machine 1, and is output as rotation of the shaft 12. The rotation of the shaft 12 is transmitted to an axle (not illustrated) via a transmission (not illustrated), a differential device, or the like, and a wheel (not illustrated) attached to the axle is rotationally driven, so that the vehicle travels at a predetermined speed.

Meanwhile, in the rotary electric machine 1 according to the present embodiment, as illustrated in FIG. 2, a total of eight flux barriers 25 are formed on both sides in the circumferential direction of the four fixing portions 24 protruding on the outer periphery of the stator core 21 of the stator 20 and at positions not overlapping the fixing portions 24 in the radial direction and the circumferential direction. Therefore, in a case where the rotary electric machine 1 functions as an electric motor, distribution of a rotating magnetic flux generated by application of an alternating current to each coil (U-phase, V-phase and W-phase coils) 22 is substantially uniform in the circumferential direction of the stator core 21 (yoke 21A) including the fixing portions 24 of the stator core 21. That is, since the circumferential flow of the rotating magnetic flux in the vicinity of each fixing portion 24 of the stator core 21 (yoke 21A) is divided by the flux barrier 25, the circumferential distribution of the rotating magnetic flux in the stator core 21 (yoke 21A) approaches the circumferential distribution of the rotating magnetic flux of the stator core (yoke) without the fixing portion 24.

As described above, in the rotary electric machine 1 according to the present embodiment, since the distribution of the rotating magnetic flux generated by the plurality of coils 22 is substantially uniform in the circumferential direction of the stator core 21 (yoke 21A) including the fixing portion 24 of the stator core 21, the torque fluctuation, that is, the torque ripple of the shaft 12 of the rotor 10 is suppressed to be small, and the vibration and noise of the rotary electric machine 1 are suppressed to be low. The torque ripple indicates the variation of the output torque of the shaft 12 in percentage with respect to the average torque.

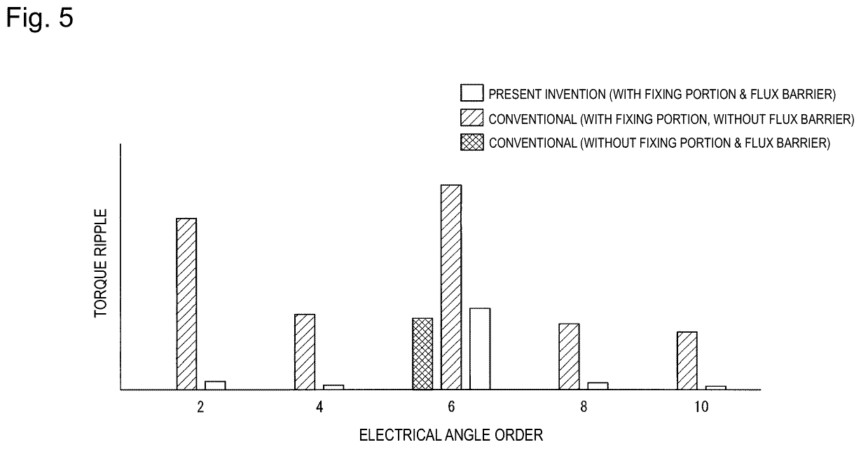

Here, the torque ripples in the electrical angle orders of the rotary electric machine 1 (with the fixing portion 24 and the flux barrier 25) according to the present embodiment are illustrated in FIG. 5 in comparison with the torque ripples of a rotary electric machine without a fixing portion and a conventional rotary electric machine with a fixing portion (without a flux barrier).

As illustrated in FIG. 5, the torque ripple of the conventional rotary electric machine without the fixing portion (fixing the stator by shrink fitting) appears only in the electrical angle order 6, and does not appear in the other electrical orders 2, 4, 8, and 10. In addition, in the conventional rotary electric machine with a fixing portion (without a flux barrier), torque ripples appear in all rotation orders, and particularly, high torque ripples appear in rotation order 6.

On the other hand, in the rotary electric machine 1 according to the present embodiment, the torque ripple can be suppressed low even in the electrical angle order 6 in which a high torque ripple appears in the conventional rotary electric machine without a fixing portion and the conventional rotary electric machine with a fixing portion (without a flux barrier), and in the other electrical angle orders 2, 4, 8, and 10, the torque ripple can be effectively suppressed low compared to the torque ripple of the conventional rotary electric machine with a fixing portion (without a flux barrier). The torque ripple of the rotary electric machine 1 according to the present embodiment is adjusted by changing the size and position of the flux barrier 25.

Further, in the rotary electric machine 1 according to the present embodiment, since the flux barrier 25 is formed at a position (a position not entering the fixing portion 24) not overlapping in the radial direction and the circumferential direction in the fixing portion 24 of the stator core 21 (yoke 21A), the fastening area of the fixing portion 24 by the bolt 23 is not reduced by the flux barrier 25. Therefore, a necessary and sufficient fastening strength is secured when the stator 20 is fixed to the motor housing 30 by the bolt 23.

On the other hand, the rotary electric machine 1 mounted on the vehicle functions as a generator at the time of deceleration by regenerative braking of the vehicle. That is, when the rotor 10 is rotationally driven by the rotational power input to the shaft 12 of the rotary electric machine 1 from the wheel side, power generation is performed in which an alternating current is generated in the coil 22 of the stator 20 by the rotating magnetic flux of the permanent magnet 13 embedded in the rotor 10. Then, the alternating current generated by the power generation is converted into a direct current by a converter (not illustrated), and the battery (not illustrated) is charged by the direct current.

Note that although the embodiment in which the present invention is applied to a rotary electric machine mounted on an electric vehicle (EV vehicle), a hybrid vehicle (HEV vehicle), or the like has been described above, the present invention is similarly applicable to a rotary electric machine to be used for any other application.

In addition, although the embodiment in which the present invention is applied to a rotary electric machine (motor generator) that functions as an electric motor and a generator has been described above, the present invention is similarly applicable to a rotary electric machine that functions only as an electric motor.

Additionally, the present invention is not limited to the embodiment described above, and various modifications can be made within the scope of the technical idea described in the scope of claims, the specification, and the drawings.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotary electric machine comprising:
a rotor in which a plurality of permanent magnets are embedded in an outer peripheral portion, the rotor being rotatable;
a stator fixed around the rotor and provided with a plurality of coils in a stator core; and
a motor housing that accommodates the rotor and the stator therein,
wherein
the stator is fixed to the motor housing by a fastener inserted into a plurality of fixing portions protruding radially outward from an outer peripheral edge of the stator core, and
a flux barrier penetrating in an axial direction is formed near the fixing portion of the stator core and at a position not overlapping the fixing portion in a radial direction.

2. The rotary electric machine according to claim 1, wherein the fixing portion is disposed at an equiangular pitch in a circumferential direction of the stator, and the flux barriers are formed on both sides of the fixing portion in a circumferential direction.

3. The rotary electric machine according to claim 1, wherein the flux barrier is formed at a position not overlapping the fixing portion in a circumferential direction.

4. The rotary electric machine according to claim 1, wherein the fixing portion is a substantially triangular portion that bulges radially outward from an outer peripheral edge of the stator, and a through hole is provided through a center portion of the fixing portion.

5. The rotary electric machine according to claim 1, wherein four of the fixing portions are formed at an equiangular pitch in a circumferential direction of the stator.
